(19) United States
(12) Patent Application Publication
(10) Pub. No.: US 2022/0413805 A1
(43) Pub. Date: Dec. 29, 2022

(54) PARTIAL SUM COMPRESSION

(71) Applicant: Samsung Electronics Co., Ltd., Suwon-si (KR)

(72) Inventors: Ling LI, Sunnyvale, CA (US); Ali SHAFIEE ARDESTANI, Santa Clara, CA (US)

(21) Appl. No.: 17/407,150

(22) Filed: Aug. 19, 2021

Related U.S. Application Data
(60) Provisional application No. 63/214,173, filed on Jun. 23, 2021.

(51) Int. Cl. G06F 7/544; G06F 7/523; G06F 7/50; G06F 7/556; G06N 3/063

(52) U.S. Cl. CPC G06F 7/5443; G06F 7/523; G06F 7/50; G06F 7/556; G06N 3/063

(57) ABSTRACT

A method for performing a neural network operation. In some embodiments, method includes: calculating a first plurality of products, each of the first plurality of products being the product of a weight and an activation; calculating a first partial sum, the first partial sum being the sum of the products; and compressing the first partial sum to form a first compressed partial sum.

### CROSS-REFERENCE TO RELATED APPLICATION(S)

The present application claims priority to and the benefit of U.S. Provisional Application No. 63/214,173 filed Jun. 23, 2021, entitled “PARTIAL SUM COMPRESSION FOR CONVOLUTION OPERATIONS IN NEURAL NETWORKS”, the entire content of which is incorporated herein by reference.

### FIELD

One or more aspects of embodiments according to the present disclosure relate to neural network processing, and more particularly to a system and method for encoding partial sums or scaling factors.

### BACKGROUND

In an artificial neural network, certain operations, such as calculating a convolution, may involve calculating partial sums and subsequently summing the partial sums. These operations may be burdensome for a processing circuit performing them, both in terms of storage requirements for the partial sums, and in terms of bandwidth used to move the partial sums to and from storage.

Thus, there is a need for an improved system and method for performing neural network calculations.

### SUMMARY

According to an embodiment of the present disclosure, there is provided a method, including: performing a neural network inference operation, the performing of the neural network inference operation including: calculating a first plurality of products, each of the first plurality of products being the product of a weight and an activation; calculating a first partial sum, the first partial sum being the sum of the products; and compressing the first partial sum to form a first compressed partial sum.

In some embodiments, the first compressed partial sum has a size, in bits, at most 0.85 that of the first partial sum.

In some embodiments, the first compressed partial sum has a size, in bits, at most 0.5 that of the first partial sum.

In some embodiments, the first compressed partial sum includes an exponent and a mantissa.

In some embodiments, the first partial sum is an integer, and the exponent is an n-bit integer equal to 2ⁿ−1 less an exponent difference, the exponent difference being the difference between: the bit position of the leading 1 in a limit number, and the bit position of the leading 1 in the first partial sum.

In some embodiments, n=4

In some embodiments: the first compressed partial sum further includes a sign bit, and the mantissa is a 7-bit number excluding an implicit 1.

In some embodiments: the first partial sum is greater than the limit number, the exponent equals 2ⁿ−1, and the mantissa of the first compressed partial sum equals a mantissa of the limit number.

In some embodiments, the performing of the neural network inference operation further includes: calculating a second plurality of products, each of the second plurality of products being the product of a weight and an activation; calculating a second partial sum, the second partial sum being the sum of the products; and compressing the second partial sum to form a second compressed partial sum.

In some embodiments, the method further includes adding the first compresses partial sum and the second compressed partial sum.

According to an embodiment of the present disclosure, there is provided a system, including: a processing circuit configured to perform a neural network inference operation, the performing of the neural network inference operation including: calculating a first plurality of products, each of the first plurality of products being the product of a weight and an activation; calculating a first partial sum, the first partial sum being the sum of the products; and compressing the first partial sum to form a first compressed partial sum. In some embodiments, the first compressed partial sum has a size, in bits, at most 0.85 that of the first partial sum.

In some embodiments, the first compressed partial sum has a size, in bits, at most 0.5 that of the first partial sum.

In some embodiments, the first compressed partial sum includes an exponent and a mantissa.

In some embodiments, the first partial sum is an integer, and the exponent is an n-bit integer equal to 2ⁿ−1 less an exponent difference, the exponent difference being the difference between: the bit position of the leading 1 in a limit number, and the bit position of the leading 1 in the first partial sum.

In some embodiments, n=4

In some embodiments: the first compressed partial sum further includes a sign bit, and the mantissa is a 7-bit number excluding an implicit 1.

In some embodiments: the first partial sum is greater than the limit number, the exponent equals 2ⁿ−1, and the mantissa of the first compressed partial sum equals a mantissa of the limit number.

According to an embodiment of the present disclosure, there is provided a system, including: means for processing configured to perform a neural network inference operation, the performing of the neural network inference operation including: calculating a first plurality of products, each of the first plurality of products being the product of a weight and an activation; calculating a first partial sum, the first partial sum being the sum of the products; and compressing the first partial sum to form a first compressed partial sum.

In some embodiments: the first compressed partial sum includes an exponent and a mantissa; the first partial sum is an integer; and the exponent is an n-bit integer equal to 2ⁿ−1 less an exponent difference, the exponent difference being the difference between: the bit position of the leading 1 in a limit number, and the bit position of the leading 1 in the first partial sum.

### BRIEF DESCRIPTION OF THE DRAWINGS

These and other features and advantages of the present disclosure will be appreciated and understood with reference to the specification, claims, and appended drawings wherein:

FIG. 1A is a block diagram of a portion of a processing circuit, according to an embodiment of the present disclosure;

FIG. 1B is a data flow diagram, according to an embodiment of the present disclosure;

FIG. 1C is a data flow diagram, according to an embodiment of the present disclosure;

FIG. 1D is a data flow diagram, according to an embodiment of the present disclosure;

FIG. 1E is a bit function diagram, according to an embodiment of the present disclosure;

FIG. 1F is a bit function and value table, according to an embodiment of the present disclosure;

FIG. 1G is a bit function and value table, according to an embodiment of the present disclosure;

FIG. 1H is a bit function and value table, according to an embodiment of the present disclosure;

FIG. 1I is a data size mapping table, according to an embodiment of the present disclosure;

FIG. 1J is an encoding diagram, according to an embodiment of the present disclosure;

FIG. 1K is a bit function and value table, according to an embodiment of the present disclosure;

FIG. 1L is a set of bit function and value tables, according to an embodiment of the present disclosure;

FIG. 2A is a table of encoding methods, according to an embodiment of the present disclosure;

FIG. 2B is a table of encoding methods, according to an embodiment of the present disclosure;

FIG. 3A is a graph of performance results, according to an embodiment of the present disclosure;

FIG. 3B is a table of performance results, according to an embodiment of the present disclosure;

FIG. 3C is a table of performance results, according to an embodiment of the present disclosure;

FIG. 3D is a table of performance results, according to an embodiment of the present disclosure;

FIG. 3E is a graph of performance results, according to an embodiment of the present disclosure;

FIG. 3F is a table of performance results, according to an embodiment of the present disclosure;

FIG. 3G is a table of performance results, according to an embodiment of the present disclosure;

FIG. 4A is a graph of performance results, according to an embodiment of the present disclosure;

FIG. 4B is a table of performance results, according to an embodiment of the present disclosure;

FIG. 4C is a table of performance results, according to an embodiment of the present disclosure;

FIG. 4D is a table of performance results, according to an embodiment of the present disclosure;

FIG. 5A is a data flow diagram, according to an embodiment of the present disclosure;

FIG. 5B is a graph of performance results, according to an embodiment of the present disclosure;

FIG. 5C is a table of performance results, according to an embodiment of the present disclosure;

FIG. 5D is a table of performance results, according to an embodiment of the present disclosure; and

FIG. 5E is a table of performance results, according to an embodiment of the present disclosure.

### DETAILED DESCRIPTION

The detailed description set forth below in connection with the appended drawings is intended as a description of exemplary embodiments of a system and method for neural network processing provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

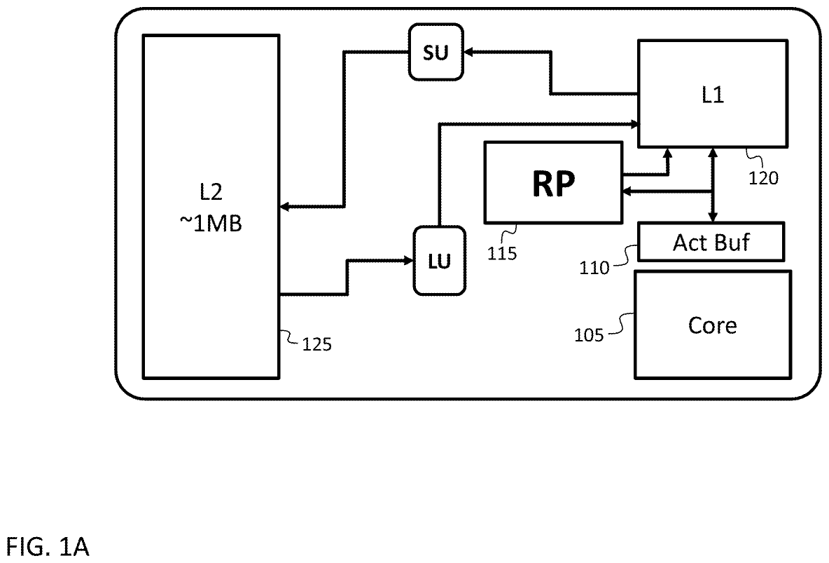

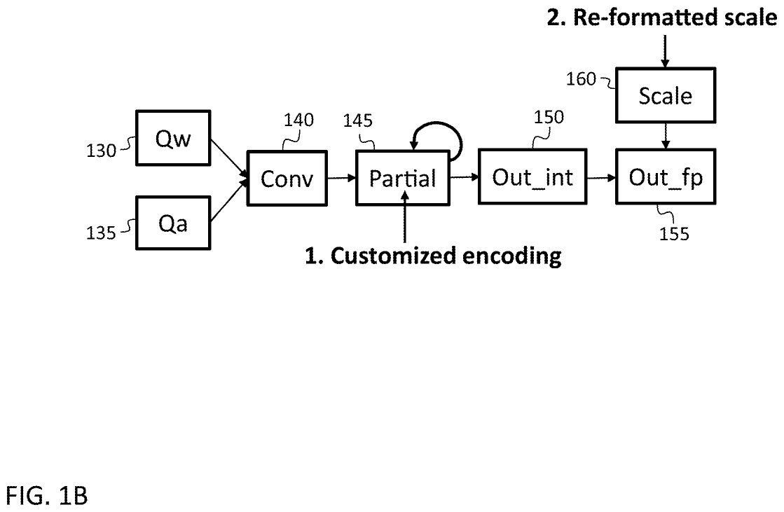

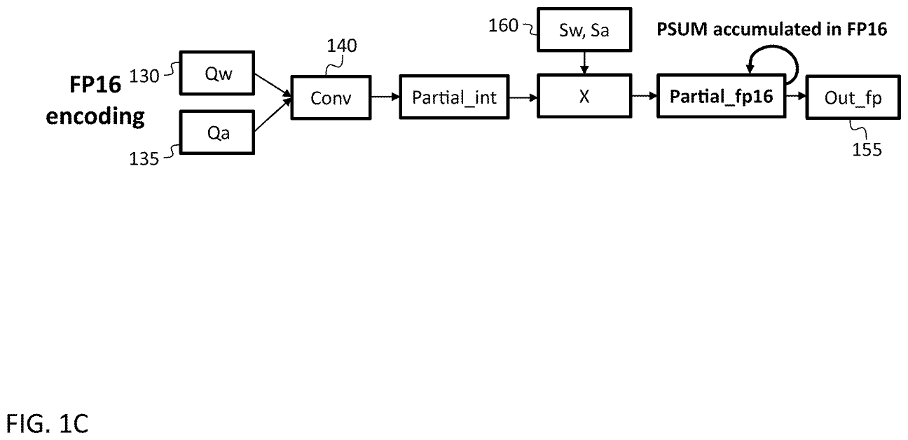

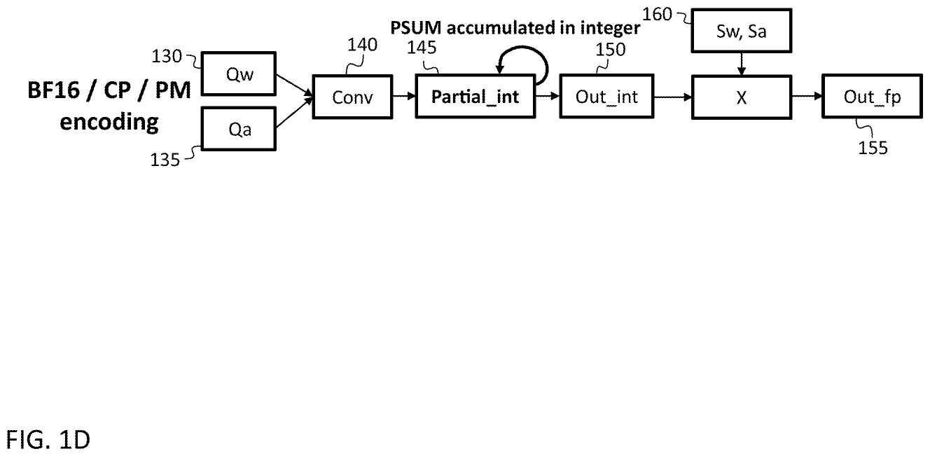

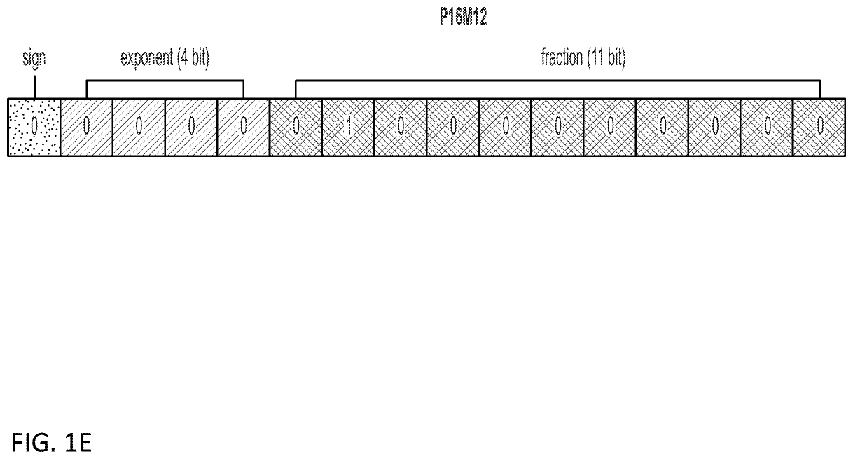

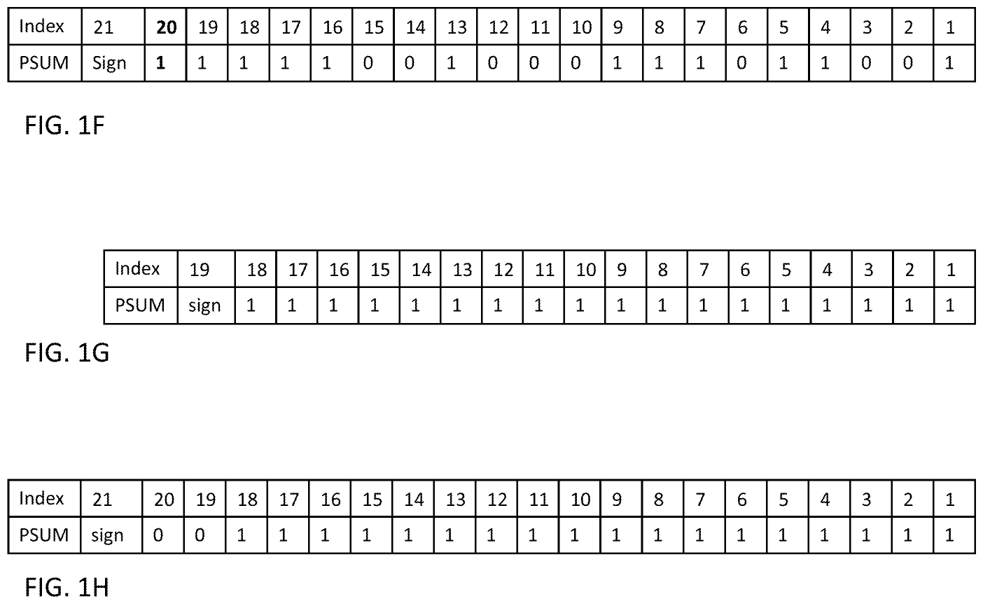

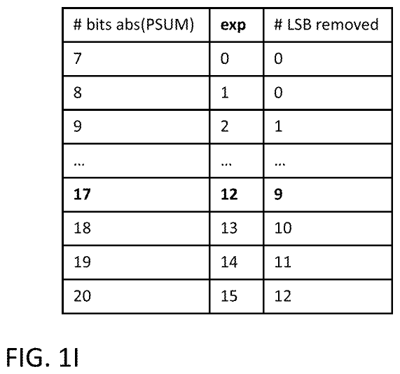

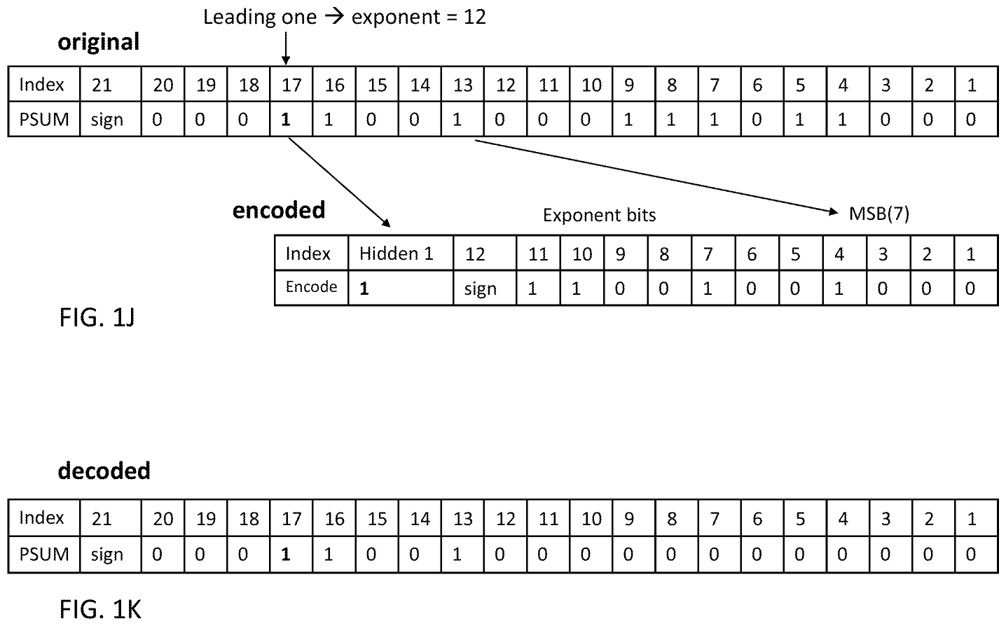

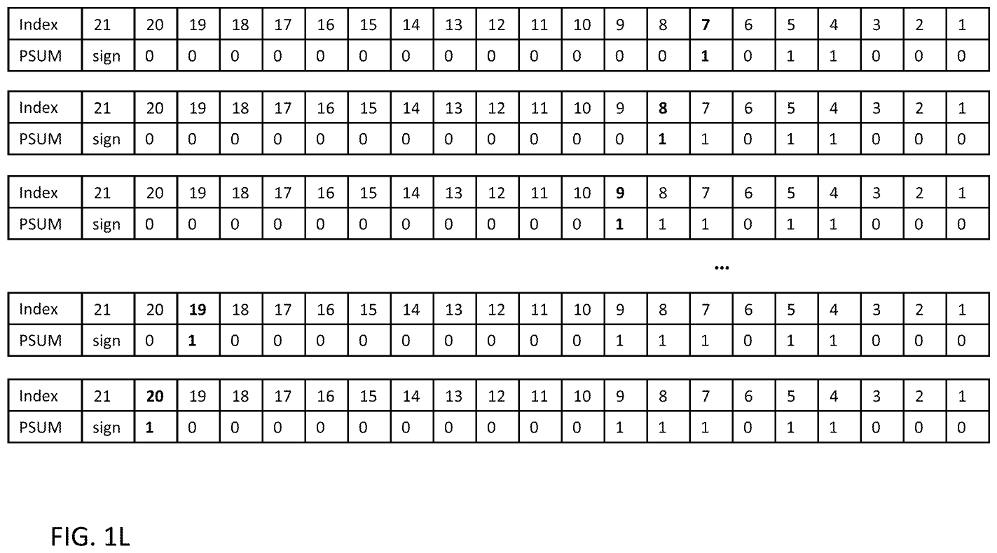

FIG. 1A shows a portion of a processing circuit configured to perform neural network inference operations involving convolutions. Activations (from an activation buffer 110) and weights are fed to a core 105, which multiplies each activation by a weight and returns the products to a return path 115. In the return path, the products may be summed to form partial sums and then stored in an L1 cache 120 or in an L2 cache 125 for later combination with other partial sums. Before being stored in the L1 cache 120 or in the L2 cache 125, the partial sums may be encoded, or “compressed”, as discussed in further detail below, to reduce the bandwidth and storage space required for saving the partial sums.

FIG. 1B is a data flow diagram showing a weight 130 multiplied by an activation 135 as a portion of a convolution operation 140. Partial sums are accumulated in a partial sum accumulation operation 145, which produces integer partial sums 150. These partial sums may be converted to a floating point representation 155, using a customized encoding method (which may also use a scale factor 160), as discussed in further detail below, to reduce the size, in bits, of each partial sum.

The input data, which may include (as mentioned above) a set of weights and a set of activations may originally be represented in floating point format. To enable more efficient multiplication operations, these floating point values may be converted to integers using a process referred to as quantization. A uniform, symmetric quantization process may be employed, although some embodiments described herein are applicable also to nonuniform and asymmetric quantization methods.

For activations and weights that are each 8-bit integers, the partial sums may in principle have a bit width of up to 31 bits. In practice, however, when the input data are images, for example, the distribution of values in the input data results in partial sums having a bit width of at most 21 bits (e.g., for ResNet50) or 19 bits (e.g., for MobileNet v2). As such, even if kept in integer form, it may not be necessary to use a 32 bit wide representation to store each partial sum as a number. Further (as discussed in further detail below), FP16 encoding, BF16 encoding, CP encoding (clipping partial sums to a fixed bit width) or PM encoding—partial sum encoding using a fixed number of most significant bits (MSB) may be employed.

In the FP16 representation, each number may be represented in the following representation:

(−1)^{sign}×2^{exp-15}×1·significandbits₂

(where sign is the sign bit, exp is the exponent, and significandbits is the set of bits of the mantissa (or “significand”) excluding the implicit leading 1), which does not accommodate the largest 19-bit (or 21-bit) integer. However, with suitable scaling, 19- and 21-bit integers may be represented using FP16. FIG. 1C shows a data flow for such an encoding, with the partial sum being accumulated after scaling of the products, using a weight scaling factor Sw and an activation scaling factor Sa, conversion of the products to FP16, and accumulation of the partial sum in the FP16 representation.

Other encoding methods, such as BF16 encoding, CP encoding, and PM encoding, may also be used (as mentioned above) to encode and compress the partial sums. FIG. 1D shows a data flow for such encoding methods, with the accumulation of the partial sum done using an integer representation, which may then be scaled and encoded to generate the encoded value.

The BF16 representation may represent each number as follows:

(−1)^{sign}×2^{(exp-127)}×1·significandbits2

where sign is the sign bit, exp is the exponent, and significandbits2 is the set of bits of the mantissa excluding the implicit leading 1. BF may have the same exponent range as FP32, but the mantissa of BF16 may be shorter; as such, FP32 may be converted to BF16 by keeping the 7 most significant bits of the mantissa and discarding the 16 least significant bits. BF16 may have the same size as a P16M12 representation (illustrated in FIG. 1E), but BF16 may have more exponent bits (8 instead of 4) and fewer mantissa bits (7 instead of 11) than P16M12. As used herein, a PkMn representation (with, e.g., k=16 and n=12 in a P16M12 representation) is a representation with 1 sign bit, (k−n) exponent bits, and (n−1) bits storing the mantissa excluding the implicit leading 1 bit. As is discussed in further detail below, a P16M12 representation may use an exponent offset to make more efficient use of the exponent bits.

CP encoding may clip partial sums that do not fit within the allocated bit width to the largest number that fits within the allocated bit width, i.e., any number larger than the largest number capable of being represented is represented by the largest number capable of being represented. For example, for CP20, a total of 20 bits is available, of which one is the sign bit, which means that the maximum magnitude that can be represented is 2¹⁹−1, and for CP19 the maximum magnitude that can be represented is 2¹⁸−1. If the partial sum is the largest 21-bit integer, then the error, if this is encoded using CP20 encoding (and the magnitude is represented as the largest 20-bit integer), is 2¹⁹, and the error, if this is encoded using CP19 encoding (and the magnitude is represented as the largest 18-bit integer), is 1.5×2¹⁹.

FIGS. 1F, 1G, and 1H show (i) an example of a 21-bit integer (in a sign and magnitude representation), having a sign bit in the 21^{st} bit position, and a value of 1 in the leading (20^{th}) bit position of the magnitude, (ii) the CP19 representation of this integer, and (iii) the result when the CP19 representation is converted back to the original 21-bit integer sign and magnitude representation. The errors introduced by the encoding (e.g., in the two most significant bits of the magnitude) may be seen by comparing FIGS. 1F and 1H.

Encoding the partial sum using a P12M8 representation (which has a size of 12 bits) (to form a compressed partial sum) may reduce the size by more than a factor of 2, e.g., if the original partial sum is an integer in a 32-bit representation. The P12M8 encoding of an integer (e.g., of the magnitude of a partial sum) may be formed based on the largest integer to be encoded, which may be referred to herein as the “limit number” used for the encoding. The encoding may proceed as follows. The four-bit exponent of the P12M8 representation is set equal to 15 (15 being equal to 2ⁿ−1 where n=4 is the number of bits in the exponent, and 15 is the maximum unsigned integer capable of being stored in the 4-bit exponent) less an exponent difference, the exponent difference being the difference between the bit position of the leading 1 in the limit number, and the bit position of the leading 1 in the integer being encoded (e.g., the partial sum). The table of FIG. 1I illustrates this process. For a magnitude (abs(PSUM)) of a partial sum having a leading one in the 17^{th} bit, for example, the exponent difference is 20−17=3, and the exponent is 15−3=12. Because 8 bits are available, in the P12M8 representation, for storing the mantissa (7 bits of which are stored explicitly in the P12M8 representation, and the leading 1 of which is stored as an implicit 1), the 9 least significant bits of the integer are discarded. This result is illustrated in the table of FIG. 1I, in the row containing the numbers 17 (the number of bits in the magnitude of the partial sum), 12 (the value of the exponent, in the P12M8 representation), and 9 (the number of least significant bits that are discarded, or “removed”). Numbers with a leading one that is in, or to the right of, the 11^{th} bit may be encoded with an exponent value of 7, and the entire magnitude of the integer (including the leading 1) may be placed in the mantissa, or “fraction” portion of P12M8 representation (for such numbers the representation does not include an implicit 1).

FIG. 1J illustrates the encoding to the P12M8 representation for an integer having the magnitude shown (e.g., for a partial sum with the absolute value shown). The encoding process is unaffected by the sign bit, which is simply copied from the sign bit of the sign and magnitude representation into the sign bit of the P12M8 representation. In the example of FIG. 1J, the leading 1 of the 17 bit integer becomes the implicit 1 (or “hidden 1”) of the P12M8 representation, and the following 7 most significant bits of the 17-bit integer become the 7 remaining bits of the 8-bit mantissa of the P12M8 representation (which includes the implicit 1). The exponent value of 12 (binary 1100) is calculated as explained above, with the exponent difference being 3. FIG. 1K shows the result that is obtained if the P12M8 representation is converted, or “decoded” back to an integer representation; it may be seen that the values of bits 1 through 9 (which were discarded during the encoding process) are all zero. As such, the encoding error is the value, in the original integer representation, of the 9-bit integer consisting of the 9 least significant bits of the original integer.

FIG. 1L shows five additional examples of integers that may be converted to a P12M8 representation. The five integers have (from top to bottom) 7 bits (i.e., a leading 1 in the 7^{th} bit position), 8 bits, 9 bits, 19 bits, and 20 bits, respectively, and may be encoded based on the corresponding rows of the table of FIG. 11.

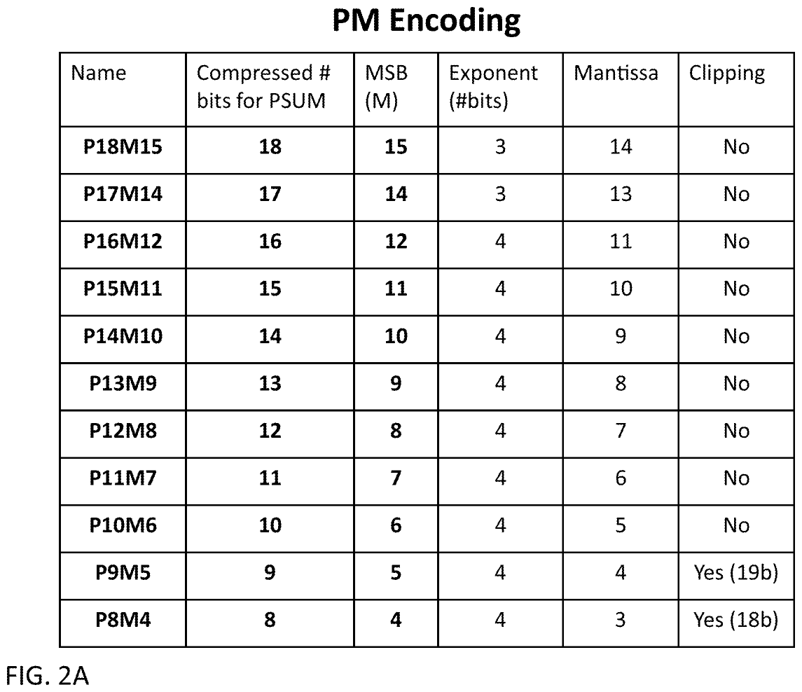

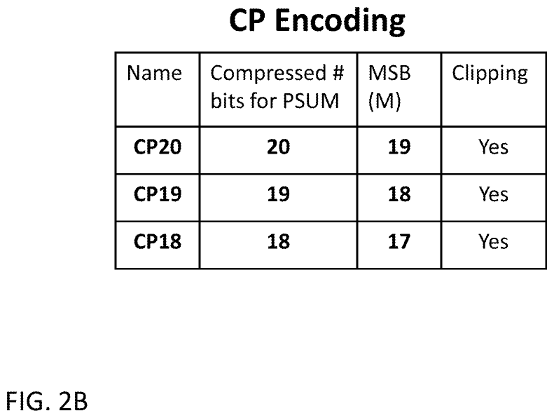

FIGS. 2A and 2B show various possibilities for encoding variants that may be employed in a ResNet50 (21 bit) neural network.

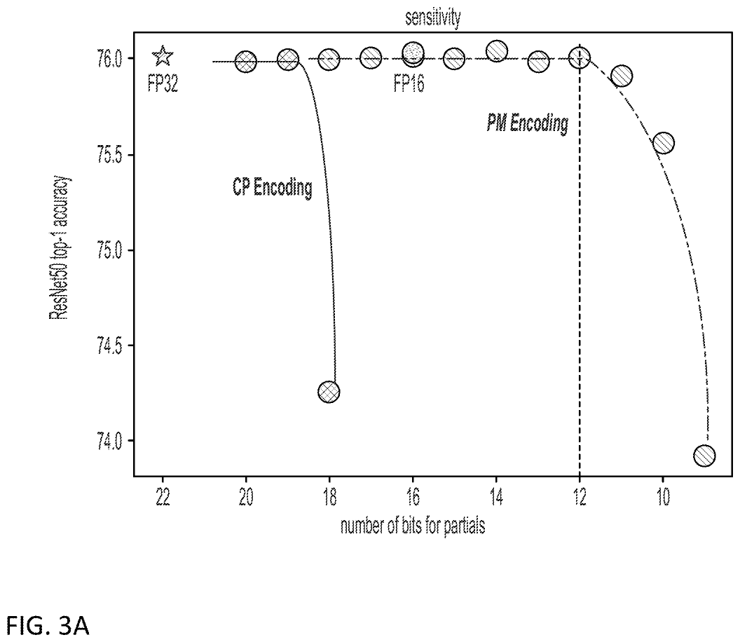

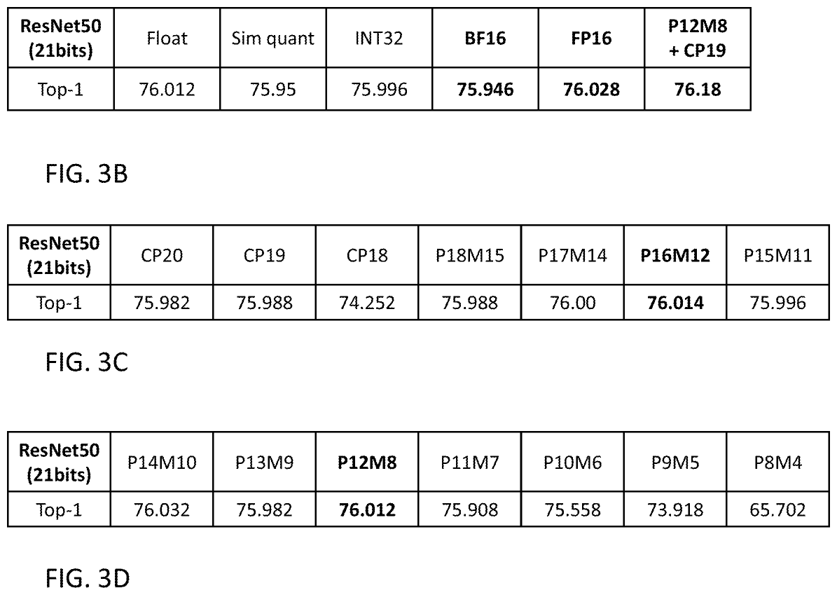

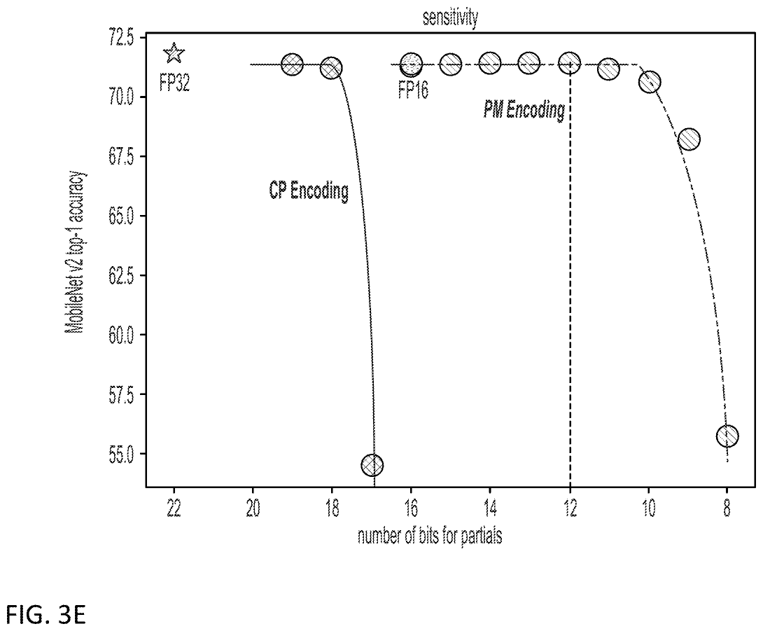

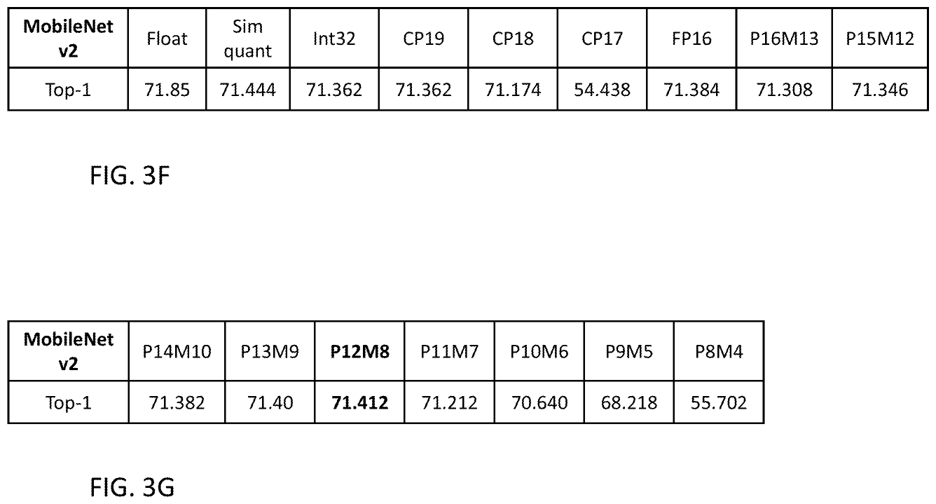

FIGS. 3A-3D show results of performance tests, done with various encoding methods, involving classification of images by a ResNet50 neural network. FIG. 3A shows the top-1 accuracy (which is the rate at which the description, of the image being classified, that is identified by the neural network as the best match is correct) as a function of the number of bits used by the encoded representation to store each partial sum. It may be seen that PM encoding is able to avoid a performance degradation with as few bits as 12 (for P12M8). FIGS. 3B-3D shows the performance results in tabular form. It may be seen that PM encoding enables the compression of partial sums down to 12 bits without a significant accuracy penalty. Each of BF16 encoding and FP16 encoding preserves the accuracy of the neural network, whereas CP encoding leads to a significant loss of accuracy beyond 18 bits. PM and CP encoding are orthogonal and may be combined; e.g., when a partial sum exceeds the limit number, then the encoding may involve using the encoded limit number (along with the sign bit of the original integer) as the encoded value.

FIGS. 3E-3G similarly show results of performance tests, done with various encoding methods, involving classification of images by a MobileNet v2 neural network (with FIG. 3E showing the results in graphical form, and FIGS. 3F and 3G showing the results in tabular form). From these tests it also may be seen that the use of a P12M8 representation for encoding of the partial sums results in no significant loss of performance.

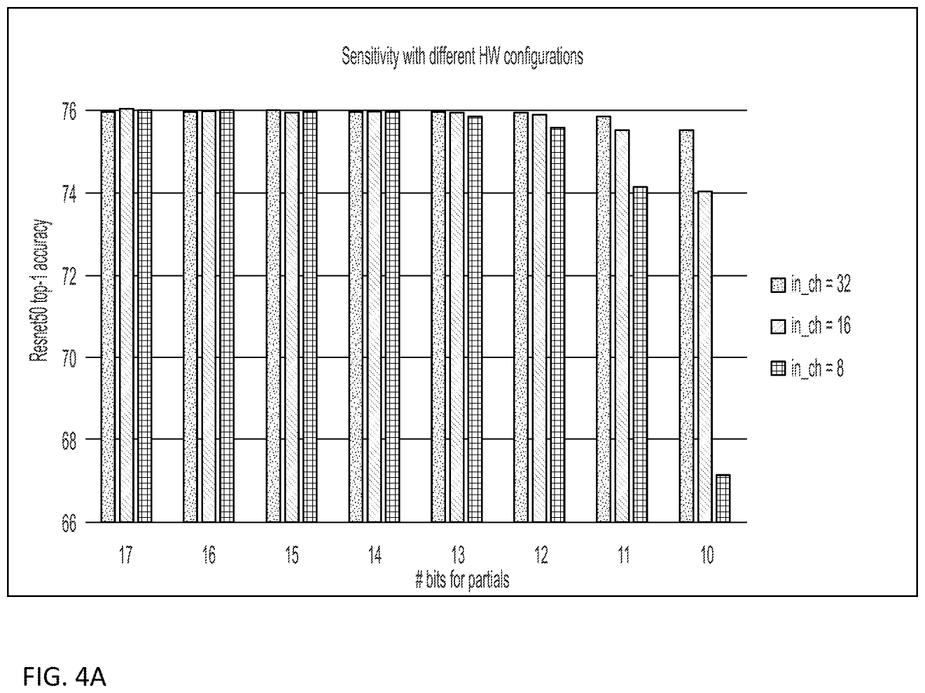

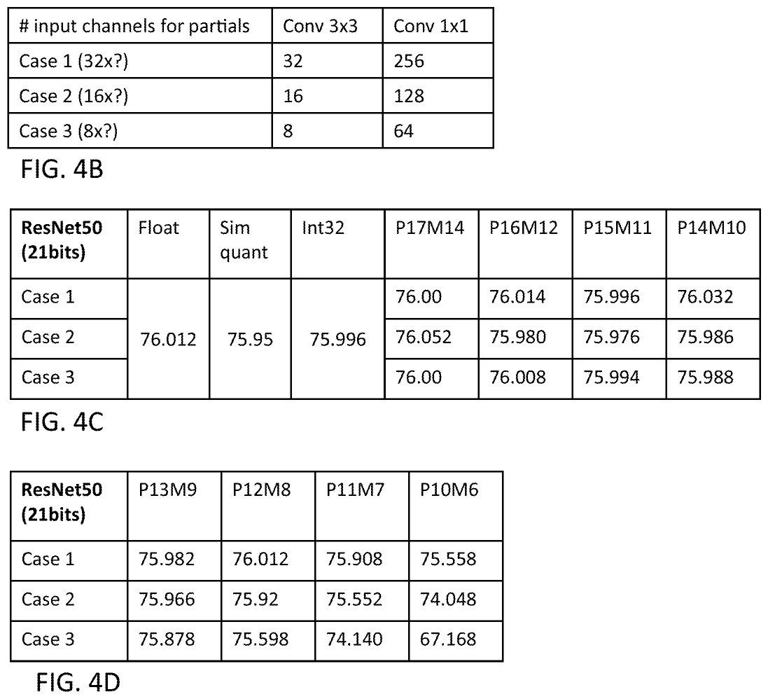

FIGS. 4A-4D show results of performance tests, done with various encoding methods and different numbers of input channels, involving classification of images by a ResNet50 neural network. The number of input channels (e.g., 32, 16, or 8 in FIGS. 4A-4D) may correspond to the number of products that are summed to form each partial sum. It may be seen that for a smaller number of input channels, the performance of the neural network degrades earlier as the number of bits of the representation used to store the partial sum decreases.

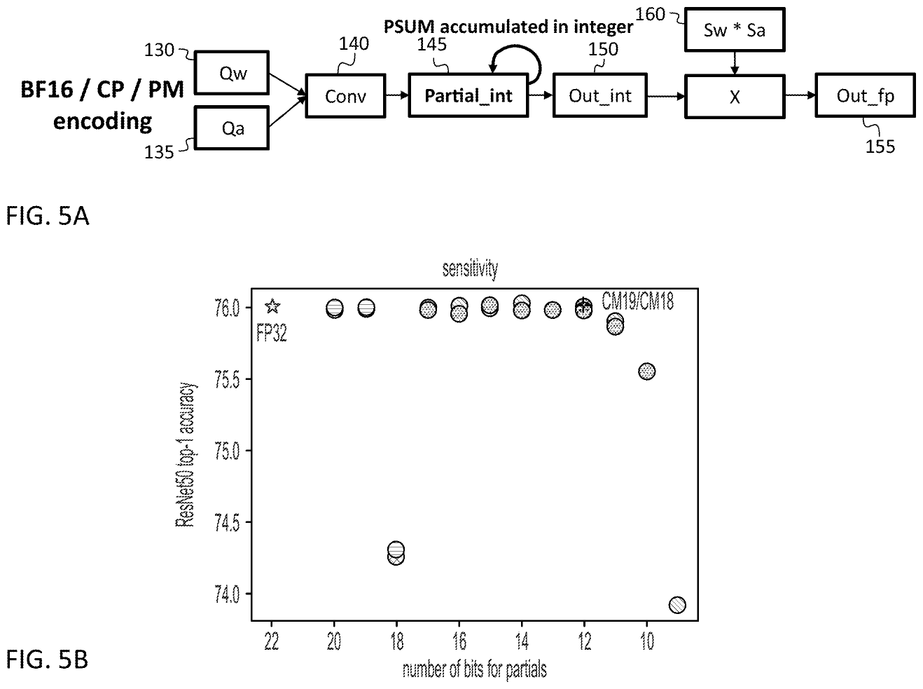

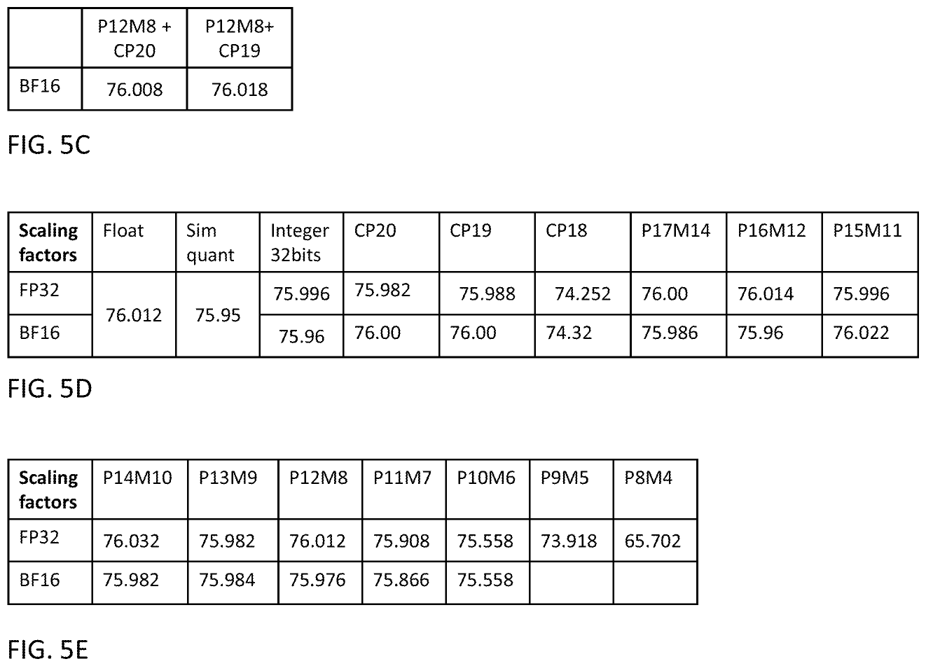

In some embodiments, the scaling factor may also be encoded to reduce bandwidth and storage requirements. FIG. 5A shows a data flow in which the scaling factor, which is the product Sw*Sa, may be encoded. FIGS. 5B-5E show results of performance tests, done with various encoding methods for the scaling factor, involving classification of images by a ResNet50 neural network (with FIG. 5B showing the results in graphical form, and FIGS. 5C-5E showing the results in tabular form). It may be seen that encoding the scaling factor from FP32 to BF16 (which reduces storage requirements by a factor of 2) does not produce a significant performance degradation for various encoding methods that may be used for the partial sums.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, when a second quantity is “within Y” of a first quantity X, it means that the second quantity is at least X−Y and the second quantity is at most X+Y. As used herein, when a second number is “within Y %” of a first number, it means that the second number is at least (1−Y/100) times the first number and the second number is at most (1+Y/100) times the first number. As used herein, the term “or” should be interpreted as “and/or”, such that, for example, “A or B” means any one of “A” or “B” or “A and B”.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein.

Although exemplary embodiments of a system and method for neural network processing have been specifically described and illustrated herein, many modifications and variations will be apparent to those skilled in the art. Accordingly, it is to be understood that a system and method for neural network processing constructed according to principles of this disclosure may be embodied other than as specifically described herein. The invention is also defined in the following claims, and equivalents thereof.

What is claimed is:

1. A method, comprising:
performing a neural network inference operation,
the performing of the neural network inference operation comprising:
calculating a first plurality of products, each of the first plurality of products being the product of a weight and an activation;
calculating a first partial sum, the first partial sum being the sum of the products; and
compressing the first partial sum to form a first compressed partial sum.

2. The method of claim 1, wherein the first compressed partial sum has a size, in bits, at most 0.85 that of the first partial sum.

3. The method of claim 1, wherein the first compressed partial sum has a size, in bits, at most 0.5 that of the first partial sum.

4. The method of claim 1, wherein the first compressed partial sum comprises an exponent and a mantissa.

5. The method of claim 4, wherein the first partial sum is an integer, and the exponent is an n-bit integer equal to 2ⁿ−1 less an exponent difference, the exponent difference being the difference between:
the bit position of the leading 1 in a limit number, and
the bit position of the leading 1 in the first partial sum.

6. The method of claim 5, wherein n=4

7. The method of claim 6, wherein:
the first compressed partial sum further comprises a sign bit, and
the mantissa is a 7-bit number excluding an implicit 1.

8. The method of claim 5, wherein:
the first partial sum is greater than the limit number,
the exponent equals 2ⁿ−1, and
the mantissa of the first compressed partial sum equals a mantissa of the limit number.

9. The method of claim 1, wherein the performing of the neural network inference operation further comprises:
calculating a second plurality of products, each of the second plurality of products being the product of a weight and an activation;
calculating a second partial sum, the second partial sum being the sum of the products; and
compressing the second partial sum to form a second compressed partial sum.

10. The method of claim 9, further comprising adding the first compresses partial sum and the second compressed partial sum.

11. A system, comprising:
a processing circuit configured to perform a neural network inference operation,
the performing of the neural network inference operation comprising:
calculating a first plurality of products, each of the first plurality of products being the product of a weight and an activation;
calculating a first partial sum, the first partial sum being the sum of the products; and
compressing the first partial sum to form a first compressed partial sum.

12. The system of claim 11, wherein the first compressed partial sum has a size, in bits, at most 0.85 that of the first partial sum.

13. The system of claim 11, wherein the first compressed partial sum has a size, in bits, at most 0.5 that of the first partial sum.

14. The system of claim 11, wherein the first compressed partial sum comprises an exponent and a mantissa.

15. The system of claim 14, wherein the first partial sum is an integer, and the exponent is an n-bit integer equal to 2ⁿ−1 less an exponent difference, the exponent difference being the difference between:
the bit position of the leading 1 in a limit number, and
the bit position of the leading 1 in the first partial sum.

16. The system of claim 15, wherein n=4

17. The system of claim 16, wherein:
the first compressed partial sum further comprises a sign bit, and
the mantissa is a 7-bit number excluding an implicit 1.

18. The system of claim 15, wherein:
the first partial sum is greater than the limit number,
the exponent equals 2ⁿ−1, and
the mantissa of the first compressed partial sum equals a mantissa of the limit number.

19. A system, comprising:
means for processing configured to perform a neural network inference operation,
the performing of the neural network inference operation comprising:
calculating a first plurality of products, each of the first plurality of products being the product of a weight and an activation;
calculating a first partial sum, the first partial sum being the sum of the products; and
compressing the first partial sum to form a first compressed partial sum.

20. The system of claim 19, wherein:
the first compressed partial sum comprises an exponent and a mantissa;
the first partial sum is an integer; and
the exponent is an n-bit integer equal to 2ⁿ−1 less an exponent difference,
the exponent difference being the difference between:
the bit position of the leading 1 in a limit number, and
the bit position of the leading 1 in the first partial sum.
